(19) United States
(12) Patent Application Publication
(10) Pub. No.: US 2024/0161372 A1
(43) Pub. Date: May 16, 2024

(54) METHOD AND SYSTEM FOR PROVIDING SERVICE FOR CONVERSING WITH VIRTUAL PERSON SIMULATING DECEASED PERSON

(71) Applicants: Gun Jang, Seongnam-si (KR); XINAPSE CO., LTD., Seoul (KR)

(72) Inventors: Gun Jang, Seongnam-si (KR); Dong Won Joo, Seoul (KR)

(73) Assignees: Gun Jang, Seongnam-si (KR); XINAPSE CO., LTD., Seoul (KR)

(21) Appl. No.: 18/543,010

(22) Filed: Dec. 18, 2023

Related U.S. Application Data
(63) Continuation of application No. PCT/KR2022/007798, filed on Jun. 2, 2022.

(30) Foreign Application Priority Data
Jun. 18, 2021 (KR) 10-2021-0079547

(51) Int. Cl. G06T 13/20; G06T 7/50; G06T 13/40; G10L 13/047; G10L 25/18; G10L 25/30

(52) U.S. Cl. CPC G06T 13/205; G06T 7/50; G06T 13/40; G10L 13/047; G10L 25/18; G10L 25/30; G06T 2207/30201

(57) ABSTRACT

A method of providing a service for a conversation with a virtual character replicating a deceased person is provided. The method of the present disclosure includes predicting a response message of a virtual character replicating a deceased person in response to a message input by a user, generating a speech corresponding to an oral utterance of the response message on the basis of speech data of the deceased person and the response message, and generating a final video of the virtual character uttering the response message on the basis of a driving video guiding the movement of the virtual character and the speech.

### CROSS-REFERENCE TO RELATED APPLICATIONS

This application is a continuation of International Application No. PCT/KR2022/007798 filed on Jun. 2, 2022, which claims priority to Korean Patent Application No. 10-2021-0079547 filed on Jun. 18, 2021, the entire contents of which are herein incorporated by reference.

### TECHNICAL FIELD

The present disclosure relates to a method and system for providing a service for a conversation with a virtual character replicating a deceased person.

### BACKGROUND ART

Recently, research on artificial intelligence (AI) technology and virtual reality (VR) technology has been active. Artificial intelligence (AI) refers to the ability of a machine to imitate intelligent human behaviors, and virtual reality (VR) refers to an artificial environment that a user may experience through sensory stimulation (e.g., visual, auditory, etc.) provided by a computer.

The purpose of the present disclosure is to provide a service allowing users to communicate with a deceased person on the basis of AI technology and VR technology.

### DETAILED DESCRIPTION OF THE DISCLOSURE

### Technical Problem

Provided are a method and system for providing a service for a conversation with a virtual character replicating a deceased person.

The technical problems to be solved are not limited to the above-described technical problems and other technical challenges can be inferred.

### Technical Solution to Problem

A method of providing a service for a conversation with a virtual character replicating a deceased person according to an aspect of the present disclosure includes: predicting a response message of the virtual character in response to a message input by a user; generating a speech corresponding to an oral utterance of the response message on the basis of speech data of the deceased person and the response message; and generating a final video of the virtual character uttering the response message on the basis of image data of the deceased person, a driving video guiding a movement of the virtual character, and the speech.

In addition, the step of predicting the response message may include predicting the response message on the basis of at least one of a relationship between the user and the deceased person, personal information about each of the user and the deceased person, and conversation data between the user and the deceased person.

In addition, the step of generating the speech may include: generating a first spectrogram by performing a short-time Fourier transform (STFT) on the speech data of the deceased person; inputting the first spectrogram into a trained artificial neural network model to output a speaker embedding vector; and generating the speech on the basis of the speaker embedding vector and the response message, wherein the trained artificial neural network model receives the first spectrogram as an input and outputs an embedding vector of speech data most similar to the speech data of the deceased person in a vector space as the speaker embedding vector.

In addition, the step of generating the speech may include generating a plurality of spectrograms corresponding to the response message on the basis of the speech data of the deceased person and the response message; selecting and outputting a second spectrogram from among the plurality of spectrograms on the basis of an alignment corresponding to each of the plurality of spectrograms; and generating the speech corresponding to the response message on the basis of the second spectrogram.

In addition, the step of selecting and outputting the second spectrogram may include selecting and outputting a second spectrogram from among the spectrograms on the basis of a predetermined threshold and a score corresponding to the alignment, and selecting and outputting the second spectrogram from among the spectrograms, when all scores are less than the threshold, regenerating the plurality of spectrograms corresponding to the response message, and selecting and outputting the second spectrogram from among the regenerated spectrograms.

In addition, the step of generating the final video may include: extracting an object corresponding to a shape of the deceased person from the image data of the deceased person; generating a motion field in which respective pixels of a frame included in the driving video are mapped to corresponding pixels in the image data of the deceased person; generating a motion video in which an object corresponding to the shape of the deceased person moves according to the motion field; and generating the final video on the basis of the motion video.

In addition, the step of generating the final video on the basis of the motion video may include:
correcting a mouth image of the object corresponding to the shape of the deceased person to move in a manner corresponding to the speech; and
generating a final video of the virtual character uttering the response message by applying the corrected mouth image to the motion video.

A computer-readable recording medium according to another aspect includes a program for executing the above-described method on a computer.

A server for providing a service for a conversation with a virtual character replicating a deceased person according to another aspect includes: a response generator predicting a response message of the virtual character in response to a message input by a user; a speech generator generating a speech corresponding to an oral utterance of the response message on the basis of speech data of the deceased person and the response message; and a video generator generating a final video of the virtual character uttering the response message on the basis of image data of the deceased person, a driving video guiding a movement of the virtual character, and the speech.

### Advantageous Effects of Disclosure

The present disclosure provides a service for a conversation with a virtual character replicating a deceased person, and may provide a user with an experience as if the user is actually maintaining a conversation with a deceased person.

### BRIEF DESCRIPTION OF DRAWINGS

FIG. 1 is a diagram schematically illustrating the operation of a system for providing a conversation with a virtual character replicating a deceased person according to an embodiment.

FIG. 2 is a diagram illustrating a screen of a user terminal according to an embodiment.

FIG. 3 is a diagram illustrating a service providing server according to an embodiment.

FIG. 4 is a diagram schematically illustrating the operation of a speech generator according to an embodiment.

FIG. 5 is a diagram illustrating a speech generator according to an embodiment.

FIG. 6 is a diagram illustrating a vector space for generating an embedding vector in the speaker encoder according to an embodiment.

FIG. 7 is a diagram for explaining the operation of a synthesizer according to an embodiment.

FIG. 8 is a diagram for explaining an example of the operation of a vocoder.

FIG. 9 is a diagram illustrating a video generator according to an embodiment.

FIG. 10 is a diagram illustrating a motion video generator according to an embodiment.

FIG. 11 is a flowchart illustrating a method of providing a service for a conversation with a virtual character replicating a deceased person according to an embodiment.

### DETAILED DESCRIPTION

A method of providing a service for a conversation with a virtual character replicating a deceased person according to an aspect may include:
predicting a response message of the virtual character in response to a message input by a user;
generating a speech corresponding to an oral utterance of the response message on the basis of speech data of the deceased person and the response message; and
generating a final video of the virtual character uttering the response message on the basis of image data of the deceased person, a driving video guiding the movement of the virtual character, and the speech.

### Mode of Disclosure

The terms used in describing embodiments of the present disclosure are selected from common terms currently in widespread use as much as possible in consideration of their functions in the present disclosure, but the meanings thereof may change according to the intention of a person having ordinary skill in the art to which the present disclosure pertains, judicial precedents, and the emergence of new technologies. In addition, in certain cases, a term which is not commonly used in the art to which the present disclosure pertains may be selected. In such a case, the meaning of the term will be described in detail in the corresponding portion of the description of the present disclosure. Therefore, the terms used in various embodiments of the present disclosure should be defined on the basis of the meanings of the terms and the descriptions provided herein, instead of being on the basis of simple names of the terms.

The embodiments of the present disclosure may be variously changed and include various embodiments, and specific embodiments will be illustrated in the drawings and described in detail. However, this is not to limit the embodiments to specific disclosed forms, and the present disclosure should be construed as encompassing all changes, equivalents, and substitutions within the technical scope and spirit of the embodiments. The terms used in the specification are merely used to describe the embodiments and are not intended to limit the embodiments.

The terms used in the embodiments have the same meanings as commonly understood by a person having ordinary skill in the art unless otherwise defined. Terms such as those defined in commonly used dictionaries should be interpreted as having meanings consistent with their meanings in the context of the relevant art, and will not be interpreted in an idealized or overly formal sense unless expressly so defined in the embodiments.

In the following detailed description, reference is made to the accompanying drawings that show, by way of illustration, specific embodiments in which the present disclosure may be put into practice. These embodiments are described in sufficient detail to enable a person having ordinary skill in the art to put the present disclosure into practice. It is to be understood that the various embodiments of the present disclosure, although different, are not necessarily mutually exclusive. For example, a particular feature, structure, or characteristic described in the specification in connection with one embodiment may be implemented within other embodiments without departing from the spirit and scope of the present disclosure. In addition, it is to be understood that the location or arrangement of individual elements within each disclosed embodiment may be modified without departing from the spirit and scope of the present disclosure. The following detailed description is, therefore, not to be taken in a limiting sense, and the scope of the present disclosure should be taken to encompass the scope defined by the claims and all equivalents thereof. In the drawings, like reference numerals refer to the same or similar components throughout various views.

In addition, technical features described individually in one figure in this present specification may be implemented individually or simultaneously.

The term “unit” used in the specification may be a hardware component such as a processor or a circuit and/or a software component executed by a hardware component such as a processor.

Hereinafter, a plurality of embodiments of the present disclosure will be described in detail with reference to the accompanying drawings so that a person having ordinary skill in the art to which the present disclosure pertains can easily put the present disclosure into practice.

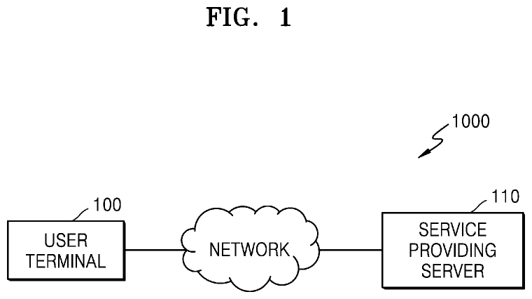

FIG. 1 is a diagram schematically illustrating the operation of a system for providing a conversation with a virtual character replicating a deceased person according to an embodiment.

A system 1000 for providing a conversation with a virtual character replicating a deceased person according to an embodiment may include a user terminal 100 and a service providing server 110. Here, in the system 1000 for providing a conversation with the virtual character replicating a deceased person illustrated in FIG. 1, only components related to an embodiment are illustrated. Accordingly, a person having ordinary skill in the art will appreciate that the system 1000 for providing a conversation with the virtual character replicating a deceased person may further include other general-purpose components in addition to the components illustrated in FIG. 1.

The system 1000 for providing a conversation with the virtual character replicating a deceased person may correspond to a chatbot system in which the virtual character replicating a deceased person and a user may maintain a conversation. The chatbot system is a system designed to respond to user questions in accordance with to predetermined response rules.

In additional, the system 1000 for providing a conversation with the virtual character replicating a deceased person may be a system based on artificial neural networks. Artificial neural networks refer to a whole set of models in which artificial neurons forming a network by connecting synapses have problem-solving capabilities by changing the strength of synaptic connections through learning.

According to an embodiment, the service providing server 110 may provide the user terminal 100 with a service allowing the user to maintain a conversation with the virtual character replicating a deceased person. For example, the user may input a specific message into a messenger chat window through the interface of the user terminal 100. The service providing server 110 may receive the input message from the user terminal 100 and transmit a response appropriate to the input message to the user terminal 100. For example, the response may correspond to simple text, but is not limited thereto, and may correspond to an image, a video, an audio signal, and the like. In another example, the response may be a combination of at least one of simple text, an image, a video, and an audio signal.

According to an embodiment, the service providing server 110 may transmit a response appropriate to the message received from the user terminal 100 on the basis of conversation data between the user and a deceased person, speech data of the deceased person, image data of the deceased person, and the like to the user terminal 100. Accordingly, the user of the user terminal 100 may feel as if he or she is maintaining a conversation with the deceased person.

The user terminal 100 and the service providing server 110 may communicate using a network. For example, networks may include local area network (LAN), wide area network (WAN), value added network (VAN), mobile radio communication network, satellite communication network, and combinations thereof, may be a comprehensive data communication network enabling respective network components illustrated in FIG. 1 to communicate properly with each other, and may include wired Internet, wireless Internet, and mobile wireless communication networks. In addition, wireless communications include, for example, wireless LAN (Wi-Fi), Bluetooth, Bluetooth low energy, ZigBee, Wi-Fi direct (WFD), ultra wideband (UWB), and infrared data association (IrDA), near field communication (NFC), and the like, but are not limited thereto.

For example, the user terminal 100 may include a smartphone, a tablet PC, a PC, a smart TV, a mobile phone, a personal digital assistant (PDA), a laptop, a media player, a micro server, a global positioning system (GPS) device, an e-book terminal, a digital broadcast terminal, a navigation device, a kiosk, an MP3 player, a digital camera, a home appliance, a camera equipped device, and other mobile or non-mobile computing devices, but are not limited thereto.

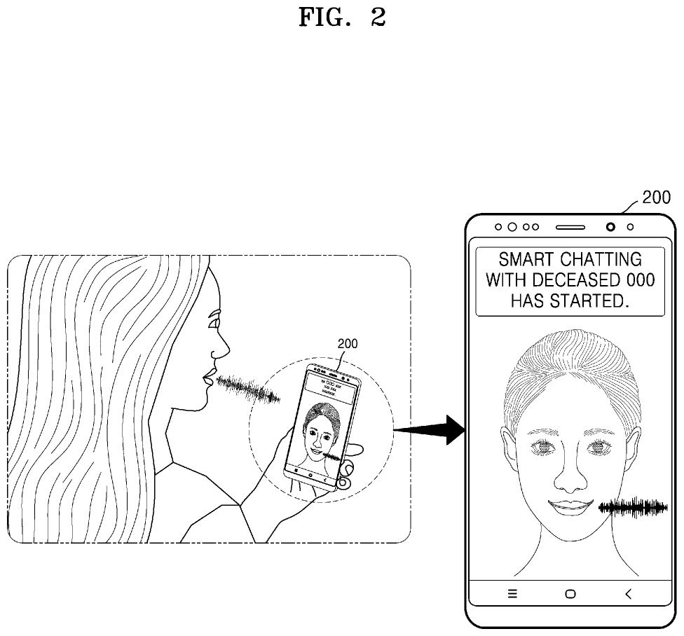

FIG. 2 is a diagram illustrating a screen of a user terminal according to an embodiment.

Referring to FIG. 2, a user terminal 200 may be provided with a service for a conversation with the virtual character replicating a deceased person by the service providing server 110. The user terminal 200 of FIG. 2 may be the same as the user terminal 100 of FIG. 1.

For example, when a user of the user terminal 200 runs an application provided by the service providing server 110, the user may maintain a conversation with the virtual character replicating a deceased person through a screen of the user terminal 200.

A user may input a message through the interface of the user terminal 200. Referring to FIG. 2, the user inputs a speech message through a speaker of the user terminal 200, but the present disclosure is not limited thereto, and the user may input the message by a variety of methods.

The service providing server 110 may receive the input message from the user terminal 200 and transmit a response message appropriate to the input message to the user terminal 200. For example, the service providing server 110 may generate a response message appropriate to the input message based on the relationship between the user and the deceased person, personal information regarding each of the user and the deceased person, conversation data between the user and the deceased person, and the like.

In addition, the service providing server 110 may generate a speech corresponding to the generated response message. For example, the service providing server 110 may generate a speech corresponding to the oral utterance of the response message on the basis of the speech data of the deceased person and the generated response message. The user terminal 200 may reproduce the speech received from the service providing server 110 through a built-in speaker of the user terminal 200.

In addition, the service providing server 110 may generate a video of the virtual character uttering the generated response message. The service providing server 110 may generate a video of the virtual character replicating a deceased person on the basis of image data the deceased person, a driving video guiding the movement of the image data, and the generated speech. For example, the generated video may correspond to a video of the virtual character that moves according to the motion in the driving video and shapes the mouth image to correspond to the generated speech.

In summarizing, the service providing server 110 may generate an appropriate response message in response to the message input by the user and generate a speech corresponding to the response message. In addition, the service providing server 110 may generate the video of the virtual character that shapes the mouth image to correspond to the generated speech.

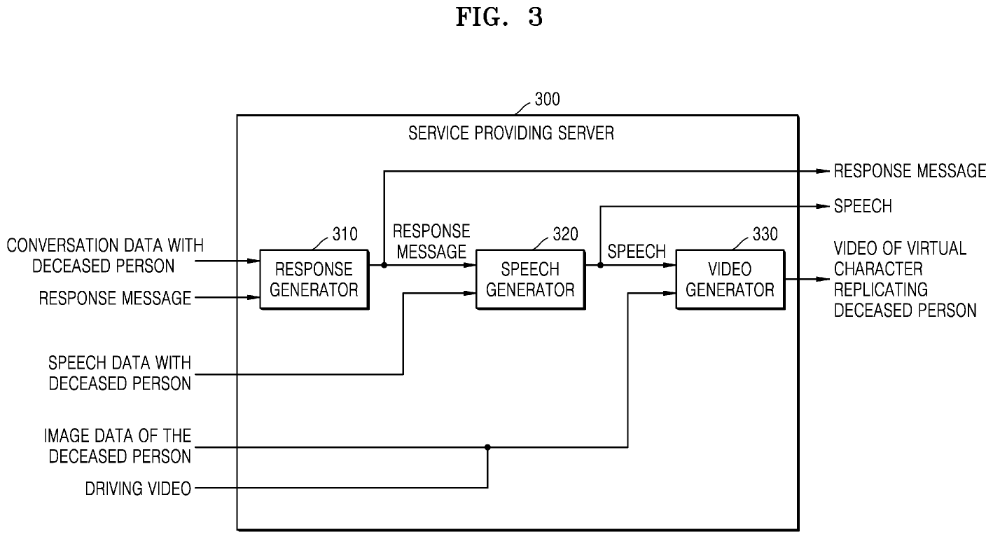

FIG. 3 is a diagram illustrating a service providing server according to an embodiment.

Referring to FIG. 3, a service providing server 300 may include a response generator 310, a speech generator 320, and a video generator 330. The service providing server 300 of FIG. 3 may be the same as the service providing server 110 of FIG. 1. Here, in the service providing server 300 illustrated in FIG. 3, only components related to an embodiment are illustrated. Accordingly, a person having ordinary skill in the art will appreciate that the service providing server 300 may further include other general-purpose components in addition to the components illustrated in FIG. 3.

Referring to FIG. 3, the response generator 310 may predict and generate a response message of the deceased person on the basis of a user message received from the user terminal 100 and data of conversations with the deceased person. The data of conversations with the deceased person may correspond to conversation data between the deceased person and the user, but is not limited thereto, and may also correspond to conversation data between the deceased person and a third party.

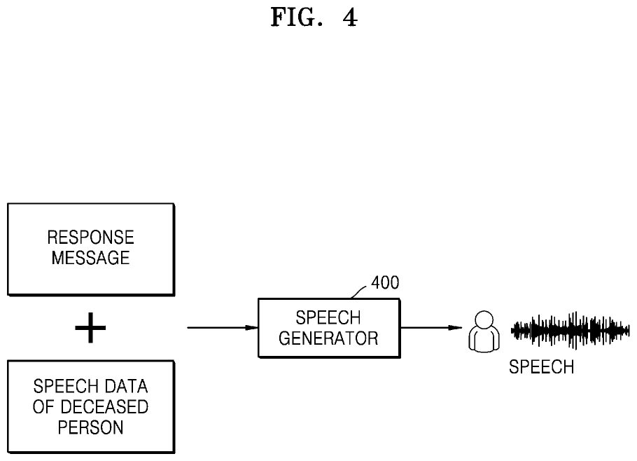

The speech generator 320 may generate a speech corresponding to the oral utterance of the response message on the basis of the response message received from the response generator 310 and the speech data of the deceased person. The operation of the speech generator 320 will be described in detail later with reference to FIGS. 4 to 8.

The video generator 330 may generate a video of the virtual character replicating a deceased person on the basis of the speech received from the speech generator 320, image data of the deceased person, and a driving video guiding the movement.

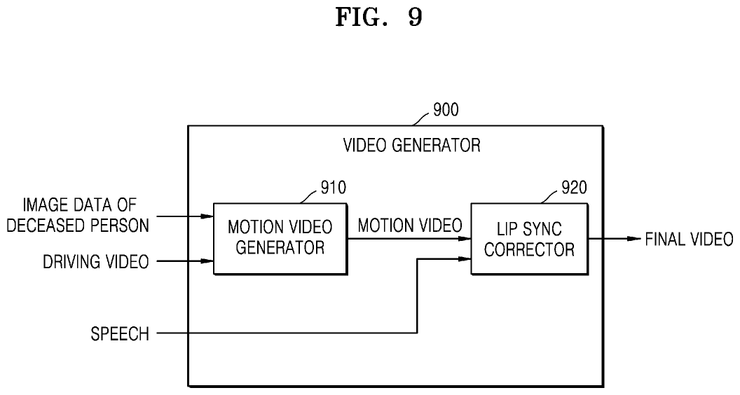

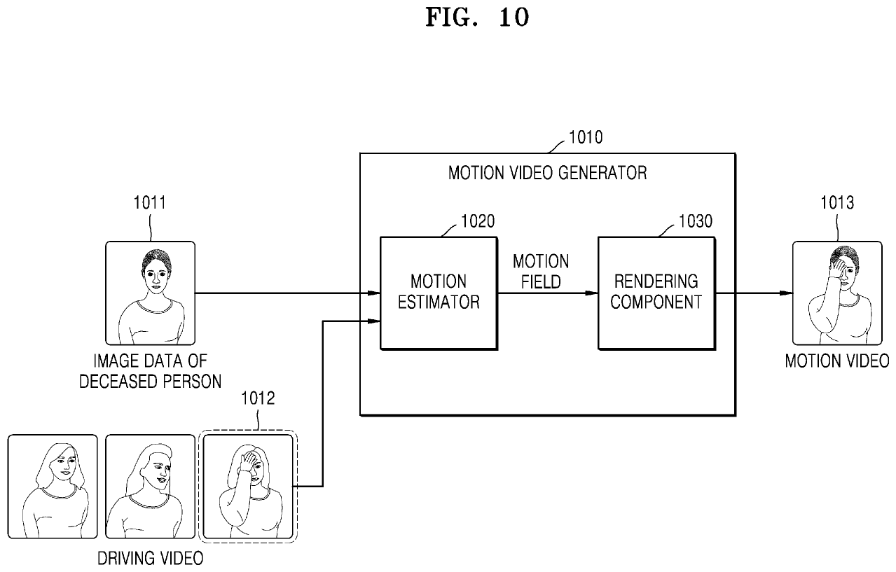

For example, the video generator 330 may extract an object corresponding to the shape of the deceased person from the image data of the deceased person and generate a video in which the object corresponding to the shape of the deceased person moves according to the motion in the driving video guiding the movement. In addition, the video generator 330 may correct the mouth image of the object corresponding to the shape of the deceased person to be shaped according to the speech signal received from the speech generator 320. Finally, the video generator 330 may generate a video of the virtual character uttering a response message by applying the corrected mouth image to the video in which the object corresponding to the shape of the deceased person moves. The operation of the video generator 330 will be described in detail later with reference to FIGS. 9 and 10.

FIG. 4 is a diagram schematically illustrating the operation of a speech generator according to an embodiment.

Referring to FIG. 4, a speech generator 400 may receive the response message received from the above-described response generator of FIG. 3 and the speech data of the deceased person. The speech generator 400 of FIG. 4 may be the same as the above-described speech generator 320 of FIG. 3.

The speech data of the deceased person may correspond to a speech signal or a speech sample representing the speech characteristics of the deceased person. For example, the speech data of the deceased person may be received from an external device through a communication component included in the speech generator 400.

The speech generator 400 may output a speech based on the response message received as an input and the speech data of the deceased person. For example, the speech generator 400 may output a speech for the response message reflecting the speech characteristics of the deceased person. The speech characteristics of the deceased person may include at least one of various elements such as speeches of the deceased person, rhythms, pitches, and emotions. That is, the output speech may be a speech that sounds like the deceased person naturally pronouncing the response message.

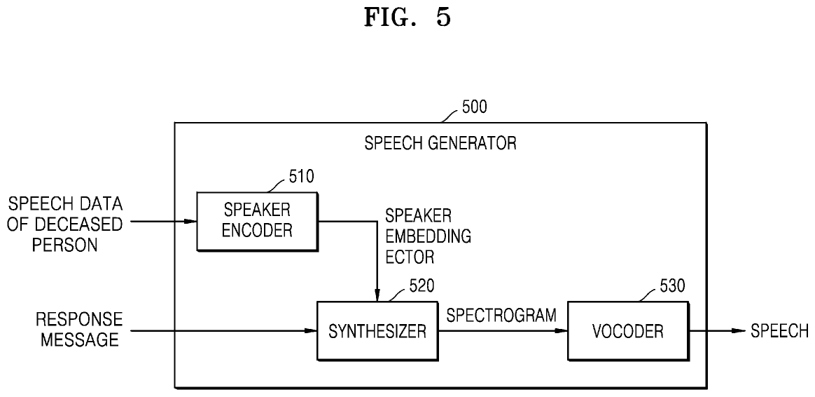

FIG. 5 is a diagram illustrating a speech generator according to an embodiment.

A speech generator 500 of FIG. 5 may be the same as the speech generator 400 of FIG. 4.

Referring to FIG. 5, the speech generator 500 may include a speaker encoder 510, a synthesizer 520, and a vocoder 530. Here, in the speech generator 500 illustrated in FIG. 5, only components related to an embodiment are illustrated. Accordingly, a person having ordinary skill in the art will appreciate that the speech generator 500 may further include other general-purpose components in addition to the components illustrated in FIG. 5.

The speech generator 500 of FIG. 5 may receive speech data of the deceased person and a response message as inputs and output a speech.

For example, the speaker encoder 510 of the speech generator 500 may receive the speech data of the deceased person as an input and generate a speaker embedding vector. The speech data of the deceased person may correspond to a speech signal or a speech sample of the deceased person. The speaker encoder 510 may receive the speech signal or the speech sample of the deceased person, extract the speech characteristics of the deceased person, and represent the extracted speech characteristics as a speaker embedding vector.

The speaker encoder 510 may represent discontinuous data values included in the speech data of the deceased person as a vector consisting of continuous numbers. For example, the speaker encoder 510 may generate an embedding vector based on at least one or a combination of two or more of various artificial neural network models such as a pre-net, a CBHG module, a deep neural network (DNN), a convolutional neural network (CNN), a recurrent neural network (RNN), a long short-term memory network (LSTM), and a bidirectional recurrent deep neural network (BRDNN).

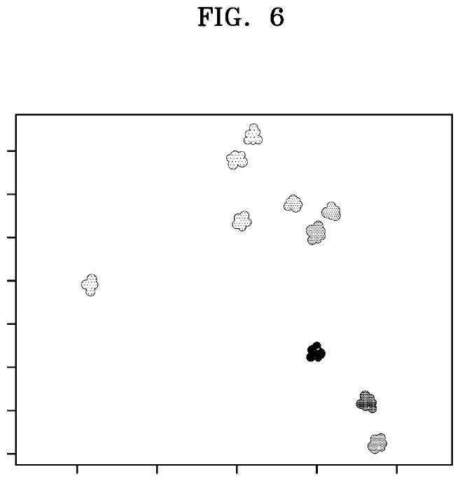

FIG. 6 is a diagram illustrating a vector space for generating an embedding vector in the speaker encoder according to an embodiment.

According to an embodiment, a speaker encoder 510 may generate a first spectrogram by performing short-time Fourier transform (STFT) on the speech data of the deceased person. The speaker encoder 510 may generate an embedding vector by inputting the first spectrogram to a learned artificial neural network model.

A spectrogram is a visualization and a graphical representation of the spectrum of the speech signal. The x-axis of the spectrogram represents time, the y-axis of the spectrogram represents frequencies, and the value of each time frequency may be displayed in color according to the magnitude of the value. The spectrogram may be the result of the short-time Fourier transform (STFT) performed on continuously given speech signals.

The STFT is a method of dividing a speech signal into sections having predetermined lengths and applying a Fourier transform to each section. At this time, because the result of the STFT performed on the speech signal is a complex value, a spectrogram containing only magnitude information may be generated by taking the absolute value of the complex value and discarding phase information.

The speaker encoder 510 may display spectrograms corresponding to various speech data and embedding vectors corresponding to the spectrograms in a vector space. The speaker encoder 510 may input a first spectrogram generated from the speech data of the deceased person to the trained artificial neural network model and output an embedding vector of speech data most similar to the speech data of the deceased person in the vector space as the speaker embedding vector. That is, the trained artificial neural network model may receive the first spectrogram as an input and generate the embedding vector matching a specific point in the vector space.

Returning to FIG. 5, the synthesizer 520 of the speech generator 500 may receive the response message and the embedding vector representing the speech characteristics of the deceased person as inputs and output a spectrogram.

For example, the synthesizer 520 may include a text encoder (not shown) and a decoder (not shown). Here, a person having ordinary skill in the art will appreciate that the synthesizer 520 may further include other general-purpose components in addition to the above-described components.

The embedding vector representing the speech characteristics of the deceased person may be generated by the speaker encoder 510 as described above, and the text encoder (not shown) or the decoder (not shown) of the synthesizer 520 may receive the speaker embedding vector representing the speech characteristics of the deceased person from the speaker encoder 510.

The text encoder (not shown) of the synthesizer 520 may receive the response message as an input and generate a text embedding vector. The response message may contain a sequence of characters in a particular natural language. For example, the sequence of characters may include alphabetic characters, numbers, punctuation marks, or other special characters.

The text encoder (not shown) may split the input response message into syllables, characters, or phonemes and input the split texts into the artificial neural network model. For example, the text encoder (not shown) may generate a text embedding vector based on at least one or a combination of two or more of various artificial neural network models such as a pre-net, a CBHG module, a DNN, a CNN, an RNN, an LSTM, and a BRDNN.

In another example, the text encoder (not shown) may split the input text into a plurality of short texts and generate a plurality of text embedding vectors for each of the short texts.

The decoder (not shown) of the synthesizer 520 may receive the speaker embedding vector and the text embedding vector as inputs from the speaker encoder 510. In another example, the decoder (not shown) of the synthesizer 520 may receive the speaker embedding vector as an input from the speaker encoder 510 and the text embedding vector as inputs from the text encoder (not shown).

The decoder (not shown) may input the speaker embedding vector and the text embedding vectors into the artificial neural network model to generate a spectrogram corresponding to the input response message. That is, the decoder (not shown) may generate the spectrogram for the response message reflecting the speech characteristics of the deceased person. In another example, the decoder (not shown) may generate a mel spectrogram for the response message reflecting the speech characteristics of the deceased person, but is not limited thereto.

Here, the mel spectrogram is obtained by readjusting the frequency interval of a spectrogram in the mel scale. The human hearing system is more sensitive to low frequencies than to high frequencies, and this characteristic is reflected in the mel scale which expresses the relationship between physical frequencies and human-perceived frequencies. The mel spectrogram may be generated by applying a filter bank based on the mel scale to a spectrogram.

Here, although not shown in FIG. 5, the synthesizer 520 may further include an attention module for generating an attention alignment. The attention module is a module that learns which output of all time steps of the text encoder (not shown) is most associated with an output of a specific time step of the decoder (not shown). A higher quality spectrogram or mel spectrogram may be output using the attention module.

The vocoder 530 of the speech generator 500 may generate the spectrogram output by the synthesizer 520 as an actual speech.

For example, the vocoder 530 may generate the spectrogram output by the synthesizer 520 as an actual speech using an inverse short-time Fourier transform (ISTFT). However, because the spectrogram or mel spectrogram does not contain phase information, a perfect actual speech signal may not be restored with the ISTFT alone.

Accordingly, the vocoder 530 may generate the spectrogram output by the synthesizer 520 as an actual speech using, for example, the Griffin-Lim algorithm. The Griffin-Lim algorithm is an algorithm that estimates phase information from the magnitude information about the spectrogram or mel spectrogram.

In another example, the vocoder 530 may generate the spectrogram output by the synthesizer 520 as an actual speech, for example, on the basis of a neural vocoder.

The neural vocoder is an artificial neural network model that generates a speech by receiving a spectrogram or mel spectrogram as an input. The neural vocoder may learn the relationship between a spectrogram or mel spectrogram and an actual speech from a large amount of data and may generate a high quality speech accordingly.

The neural vocoder may correspond to a vocoder based on an artificial neural network model such as WaveNet, parallel WaveNet, WaveRNN, WaveGlow, or MelGAN, but is not limited thereto.

The synthesizer 520 according to an embodiment may generate a plurality of spectrograms (or mel spectrograms). Specifically, the synthesizer 520 may generate a plurality of spectrograms (or mel spectrograms) for a single pair of inputs consisting of the response message and the speaker embedding vector generated from the speech data of the deceased person.

In addition, the synthesizer 520 may calculate an attention alignment score corresponding to each of the plurality of spectrograms (or mel spectrograms). Specifically, the synthesizer 520 may calculate an encoder score, a decoder score, and a total score of the attention alignment. Accordingly, the synthesizer 520 may select one of the plurality of spectrograms (or mel spectrograms) on the basis of the calculated score. Here, the selected spectrogram (or mel spectrogram) may represent a synthesized speech having highest quality for the single pair of inputs.

In addition, the vocoder 530 may generate a speech using the spectrogram (or mel spectrogram) transmitted from the synthesizer 520. At this time, the vocoder 530 may select one of a plurality of algorithms to be used for generating the speech according to the expected quality and the expected generation speed of the speech to be generated. In addition, the vocoder 530 may generate the speech on the basis of the selected algorithm.

Accordingly, the speech generator 500 may generate a synthesized speech meeting quality and speed conditions.

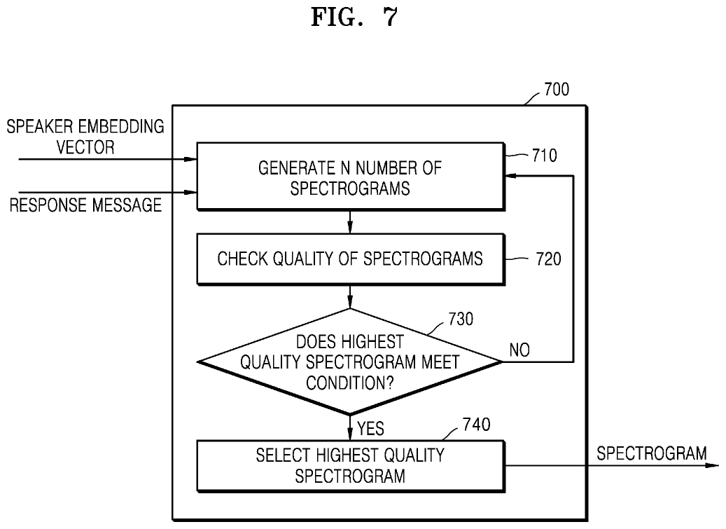

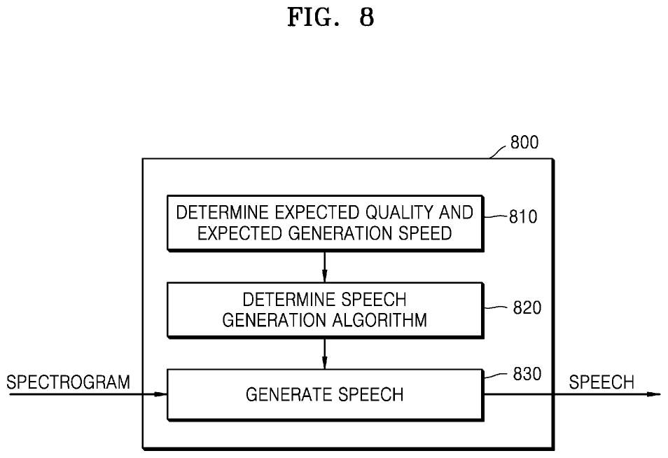

Hereinafter, examples in which the synthesizer 520 and the vocoder 530 operate will be described in detail with reference to FIGS. 7 and 8. Hereinafter, the synthesizer 520 will be described as selecting one of the plurality of spectrograms (or the plurality of mel spectrograms), but the module selecting the spectrogram (or mel spectrogram) may not be the synthesizer 520. For example, the spectrogram (or mel spectrogram) may be selected by a separate module included in the speech generator 500 or another module separate from the speech generator 500.

In addition, hereinafter, the spectrogram and the mel spectrogram will be described using terms that may be used interchangeably. In other words, although it is described below as a spectrogram, it may be replaced with a mel spectrogram. In addition, hereinafter, although a mel spectrogram is described, the mel spectrogram may be replaced with a spectrogram.

FIG. 7 is a diagram for explaining the operation of the synthesizer according to an embodiment.

A synthesizer 700 illustrated in FIG. 7 may be the same module as the synthesizer 520 illustrated in FIG. 5. Specifically, the synthesizer 700 may generate a plurality of spectrograms using a speaker embedding vector generated from a response message and a speech data of the deceased person and select one of the spectrograms.

In step 710, the synthesizer 700 generates n number of spectrograms using a single pair of speaker embedding vectors generated from the response message and the speech data of the deceased person (where n is a natural number of 2 or more).

For example, the synthesizer 700 may include an encoder neural network and an attention-based decoder recurrent neural network. Here, an encoder neural network processes a sequence of input text to generate an encoded representation of each of characters included in the sequence of input text. Then, an attention-based decoder recurrent neural network processes a decoder input and the encoded representation to generate a single frame of the spectrogram for each decoder input in the sequence input from the encoder neural network. The synthesizer 700 according to an embodiment of the present disclosure generates a plurality of spectrograms using a single speaker embedding vector generated from a single response message and the speech data of a deceased person. Because the synthesizer 700 includes the encoder neural network and the decoder recurrent neural network, the quality of the spectrogram may not be the same each time the spectrogram is generated. Accordingly, the synthesizer 700 generates a plurality of spectrograms in response to the single response message and the single speaker embedding vector and selects a highest quality spectrogram from among the generated spectrograms, thereby increasing the quality of the synthesized speech.

In step 720, the synthesizer 700 checks the quality of the generated spectrograms.

For example, the synthesizer 700 may check the quality of the spectrogram using an attention alignment corresponding to the spectrogram. Specifically, the attention alignment may be generated to correspond to the spectrogram. For example, when the synthesizer 700 generates a total of n number of spectrograms, the attention alignment may be generated to correspond to each of the n spectrograms. Therefore, the quality of the corresponding spectrogram may be determined on the basis of the attention alignment.

For example, when the amount of data is not large or learning is not sufficient, the synthesizer 700 may not be able to generate a high quality spectrogram. The attention alignment may be interpreted as the history of each moment that the synthesizer 700 focuses on when generating the spectrogram.

For example, when a line representing the attention alignment is dark and there is little noise, the synthesizer 700 may be interpreted as having made confident inference at each moment that the spectrogram is generated. That is, in the case of the above-described example, the synthesizer 700 may be determined to have generated a high quality spectrogram. Therefore, the quality of the attention alignment (e.g., the degree to which the color of the attention alignment is dark, the degree to which the outline of the attention alignment is clear, and the like) may be used as a very important indicator in estimating the inference quality of the synthesizer 700.

For example, the synthesizer 700 may calculate the encoder score and the decoder score of the attention alignment. In addition, the synthesizer 700 may calculate the total score of the attention alignment by combining the encoder score and the decoder score.

In step 730, the synthesizer 700 determines whether the highest quality spectrogram meets a predetermined standard.

For example, the synthesizer 700 may select an attention alignment having the highest score from among respective scores of attention alignments. Here, the score may be at least one of an encoder score, a decoder score, and a total score. In addition, the synthesizer 700 may determine whether the score meets a predetermined standard.

Selecting the highest score by the synthesizer 700 is equivalent to selecting the highest quality spectrogram from among the n number of spectrograms generated in step 710. Accordingly, there is the same effect as the synthesizer 700 checking whether the highest quality spectrogram among the n number of spectrograms meets the predetermined standard by comparing the highest score with the predetermined standard.

For example, the predetermined standard may be a specific value of the score. That is, the synthesizer 700 may determine whether the highest quality spectrogram meets the predetermined standard, depending on whether the highest score is greater than or equal to the specific value.

When the highest quality spectrogram does not meet the predetermined standard, step 710 is performed. The highest quality spectrogram failing to meet the predetermined standard is equivalent to all of the remaining n−1 number of spectrograms failing to meet the predetermined standard. Accordingly, the synthesizer 700 regenerates n number of spectrograms by performs step 710 again. Subsequently, the synthesizer 700 performs steps 720 and 730 again. That is, the synthesizer 700 repeats steps 710 to 730 once or more depending on whether the highest quality spectrogram meets the predetermined standard.

When the highest quality spectrogram meets the predetermined criteria, step 740 is performed.

In step 740, the synthesizer 700 selects the highest quality spectrogram. Afterwards, the synthesizer 700 transmits the selected spectrogram to the vocoder 530.

In other words, the synthesizer 700 selects a spectrogram corresponding to a score meeting the predetermined standard in step 730. In addition, the synthesizer 700 transmits the selected spectrogram to the vocoder 530. Accordingly, the vocoder 530 may generate a high quality synthesized speech meeting the predetermined standard.

FIG. 8 is a diagram for explaining an example of the operation of a vocoder.

A vocoder 800 illustrated in FIG. 8 may be the same module as the vocoder 530 illustrated in FIG. 5. Specifically, the vocoder 800 may generate speech using a spectrogram.

In step 810, the vocoder 800 determines expected quality and an expected production speed.

The vocoder 800 affects the quality of the synthesized speech and the speed of the speech generator 500. For example, when the vocoder 800 uses a precise algorithm, the quality of the synthesized speech may be improved, but the speed at which the synthesized speech is generated may decrease. In another example, when the vocoder 800 uses a low-precision algorithm, the quality of the synthesized speech may be lowered, but the speed at which the synthesized speech is generated may increase. Accordingly, the vocoder 800 may determine the expected quality and the expected production speed of the synthesized speech and determine a speech generation algorithm accordingly.

In step 820, the vocoder 800 determines the speech generation algorithm according to the expected quality and the expected generation speed determined in step 510.

For example, when the quality of the synthesized speech is more important than the speed of generating the synthesized speech, the vocoder 800 may select a first speech generation algorithm. Here, the first speech generation algorithm may be an algorithm based on WaveRNN, but is not limited thereto.

In another example, when the speed of generating the synthesized speech is more important than the quality of the synthesized speech, the vocoder 800 may select a second speech generation algorithm. Here, the second speech generation algorithm may be an algorithm based on MeIGAN, but is not limited thereto.

In step 830, the vocoder 800 generates a speech according to the speech generation algorithm determined in step 520.

Specifically, the vocoder 800 generates the speech using the spectrogram output by the synthesizer 520.

FIG. 9 is a diagram illustrating a video generator according to an embodiment.

Referring to FIG. 9, a video generator 900 may include a motion video generator 910 and a lip sync corrector 920. The video generator 900 of FIG. 9 may be the same as the video generator 330 of FIG. 3. Here, in the video generator 900 illustrated in FIG. 9, only components related to an embodiment are illustrated. Accordingly, a person having ordinary skill in the art will appreciate that the video generator 900 may further include other general-purpose components in addition to the components illustrated in FIG. 9.

According to an embodiment, the video generator 900 may generate a final video of a virtual character replicating a deceased person on the basis of image data of the deceased person, a driving video, and a speech generated by the above-described speech generator. For example, the driving video may correspond to a video that guides the movement of the virtual character replicating a deceased person.

According to an embodiment, the motion video generator 910 may generate a motion video based on the image data and the driving video of the deceased person. The motion video may correspond to a video in which an object corresponding to the shape of the deceased person within the image data of the deceased person moves according to the driving video. For example, the motion video generator 910 may generate a motion field representing the movement in the driving video and generate a motion video on the basis of the motion field.

According to an embodiment, the lip sync corrector 920 may generate the final video of the virtual character replicating a deceased person on the basis of the motion video generated by the motion video generator 910 and the speech generated by the speech generator. As described above, the speech generated by the speech generator may be a speech that sounds like the deceased person naturally pronouncing the response message.

For example, the lip sync corrector 920 may correct the mouth image of an object corresponding to the shape of the deceased person to move in a manner corresponding to the speech generated by the speech generator. The lip sync corrector 920 may apply the corrected mouth image to the motion video generated by the motion video generator 910 to finally generate the final video of the virtual character uttering the response message.

FIG. 10 is a diagram illustrating a motion video generator according to an embodiment.

Referring to FIG. 10, a motion video generator 1010 may include a motion estimator 1020 and a rendering component 1030. The motion video generator 1010 of FIG. 10 may be the same as the above-described motion video generator 910 of FIG. 9. Here, in the motion video generator 1010 illustrated in FIG. 10, only components related to an embodiment are illustrated. Accordingly, a person having ordinary skill in the art will appreciate that the motion video generator 1010 may further include other general-purpose components in addition to the components illustrated in FIG. 10.

According to an embodiment, the motion video generator 1010 may generate a motion video based on the image data 1011 and the driving video of the deceased person. Specifically, the motion video generator 1010 may generate the motion video based on image data 1011 of the deceased person and a frame 1012 included in the driving video. For example, the motion video generator 1010 may extract an object corresponding to the shape of the deceased person from the image data 1011 of the deceased person, and the motion video generator 1010 may finally generate a motion video 1013 in which the object corresponding to the shape of the deceased person follows movements within the frame 1012 included in the driving video.

According to an embodiment, the motion estimator 1020 may generate a motion field in which respective pixels of the frame included in the driving video are mapped to corresponding pixels in the image data of the deceased person. For example, the motion field may be represented by the locations of key points included in each of the image data 1011 of the deceased person and the frame 1012 included in the driving video and local affine transformations near the key points. In addition, although not shown in FIG. 10, the motion estimator 1020 may generate an occlusion mask representing an image portion that may be generated by modifying the image data of the deceased person in the frame 1012 included in the driving video and an image portion required to be restored on the basis of context.

According to an embodiment, the rendering component 1030 may render the image of the virtual character that follows the movement in the frame 1012 included in the driving video on the basis of the motion field and the occlusion mask generated by the motion estimator 1020.

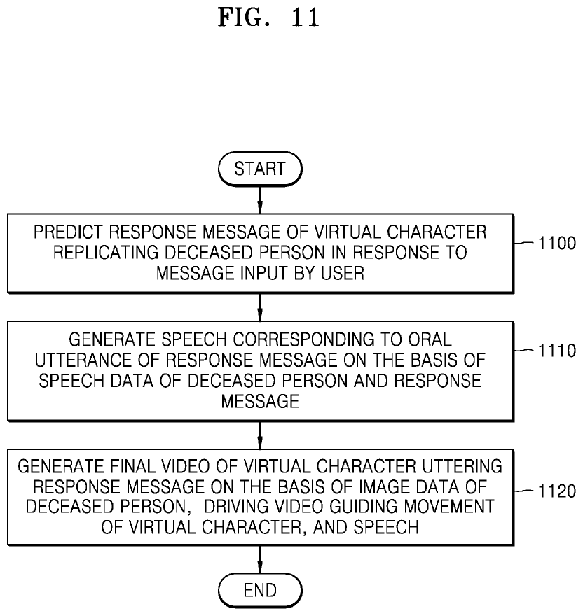

FIG. 11 is a flowchart illustrating a method of providing a service for a conversation with a virtual character replicating a deceased person according to an embodiment.

Referring to FIG. 11, in step 1100, the service providing server 110 may predict a response message of the virtual character replicating a deceased person in response to a message input by the user.

According to an embodiment, the service providing server 110 may predict a response message on the basis of at least one of the relationship between the user and the deceased person, personal information about each of the user and the deceased person, and conversation data between the user and the deceased person.

In step 1110, the service providing server 110 may generate a speech corresponding to the oral utterance of the response message on the basis of speech data of the deceased person and the response message.

According to an embodiment, the service providing server 110 may perform a short-time Fourier transform (STFT) on the speech data of the deceased person to generate a first spectrogram and input the first spectrogram to a trained artificial neural network model to output a speaker embedding vector. The service providing server 110 may generate the speech based on the speaker embedding vector and the response message. The trained artificial neural network model may receive the first spectrogram as an input and output an embedding vector of speech data most similar to the speech data of the deceased person in the vector space as the speaker embedding vector.

According to an embodiment, the service providing server 110 may generate a plurality of spectrograms corresponding to the response message on the basis of the speaker embedding vector and the response message. In addition, the service providing server 110 may select and output a second spectrogram from among the plurality of spectrograms on the basis of an alignment corresponding to each of the plurality of spectrograms, and generate a speech signal corresponding to the response message on the basis of the second spectrogram.

According to an embodiment, the service providing server 110 may select and output a second spectrogram from among the spectrograms on the basis of a predetermined threshold and a score corresponding to the alignment, when the score of all of the spectrograms is smaller than the threshold, regenerate a plurality of spectrograms corresponding to the oral utterance of the response message, and select and output a second spectrogram from among the regenerated spectrograms.

In step 1120, the service providing server 110 may generate a final video of the virtual character uttering the response message on the basis of the image data of the deceased person, a driving video guiding the movement of the virtual character, and the speech.

According to an embodiment, the service providing server 110 may extract an object corresponding to the shape of the deceased person from the image data of the deceased person and generate a motion field in which respective pixels of the frame included in the driving video are mapped to corresponding pixels in the image data of the deceased person. In addition, the service providing server 110 may generate a motion video in which the object corresponding to the shape of the deceased person moves according to the motion field and generate a final video on the basis of the motion video.

According to an embodiment, the service providing server 110 may correct the mouth image of the object corresponding to the shape of the deceased person to move in response to the speech and apply the corrected mouth image to the motion video to generate the final video of the virtual character uttering the response message.

The foregoing description of the specification is for illustrative purposes, and a person having ordinary skill in the art to which the present disclosure pertains will understand that the present disclosure may be easily modified into other specific forms without changing the technical idea or essential features of the present disclosure. Accordingly, the foregoing embodiments shall be interpreted as being illustrative, while not being limitative, in all aspects. For example, each component described to be of a single entity may be implemented in a distributed form, and likewise, components described to be distributed may be implemented in a combined form.

The scope of the embodiments is defined by the following claims rather than by the detailed description and should be construed as encompassing all changes and modifications conceived from the meaning and scope of the claims and equivalents thereof.

1. A method of providing a service for a conversation with a virtual character replicating a deceased person, the method comprising steps of:
predicting a response message of the virtual character in response to a message input by a user;
generating a speech corresponding to an oral utterance of the response message on the basis of speech data of the deceased person and the response message; and
generating a final video of the virtual character uttering the response message on the basis of image data of the deceased person, a driving video guiding a movement of the virtual character, and the speech,
wherein the step of generating the speech comprises:
generating a first spectrogram by performing a short-time Fourier transform (STFT) on the speech data of the deceased person;
inputting the first spectrogram into a trained artificial neural network model to output a speaker embedding vector; and
generating the speech on the basis of the speaker embedding vector and the response message,
wherein the trained artificial neural network model receives the first spectrogram as an input and outputs an embedding vector of speech data most similar to the speech data of the deceased person in a vector space as the speaker embedding vector.

2. The method of claim 1, wherein the step of predicting the response message comprises
predicting the response message on the basis of at least one of a relationship between the user and the deceased person, personal information about each of the user and the deceased person, and conversation data between the user and the deceased person.

3. The method of claim 1, wherein the step of generating the final video comprises:
extracting an object corresponding to a shape of the deceased person from the image data of the deceased person;
generating a motion field in which respective pixels of a frame included in the driving video are mapped to corresponding pixels in the image data of the deceased person;
generating a motion video in which an object corresponding to the shape of the deceased person moves according to the motion field; and
generating the final video on the basis of the motion video.

4. The method of claim 3, wherein the step of generating the final video on the basis of the motion video comprises:
correcting a mouth image of the object corresponding to the shape of the deceased person to move in a manner corresponding to the speech; and
generating a final video of the virtual character uttering the response message by applying the corrected mouth image to the motion video.

5. A server for providing a service for a conversation with a virtual character replicating a deceased person, the server comprising:
a response generator predicting a response message of the virtual character in response to a message input by a user;
a speech generator generating a speech corresponding to an oral utterance of the response message on the basis of speech data of the deceased person and the response message; and
a video generator generating a final video of the virtual character uttering the response message on the basis of image data of the deceased person, a driving video guiding a movement of the virtual character, and the speech,
wherein the speech generator
generates a first spectrogram by performing a short-time Fourier transform (STFT) on the speech data of the deceased person,
inputs the first spectrogram into a trained artificial neural network model to output a speaker embedding vector, and
generates the speech on the basis of the speaker embedding vector and the response message,
wherein the trained artificial neural network model receives the first spectrogram as an input and outputs an embedding vector of speech data most similar to the speech data of the deceased person in a vector space as the speaker embedding vector.

6. A non-transitory computer-readable recording medium having recorded thereon a program to cause the method of claim 1 to be executed on a computer.
